(19) United States
(12) Patent Application Publication
(10) Pub. No.: US 2013/0122479 A1
(43) Pub. Date: May 16, 2013

(54) PARENT COLLABORATION PROFESSIONAL LEARNING COMMUNITY

(71) Applicant: Donna Harla, Ponte Vedra Beach, FL (US)

(72) Inventor: Donna Harla, Ponte Vedra Beach, FL (US)

(21) Appl. No.: 13/297,654

(22) Filed: Nov. 16, 2011

(51) Int. Cl. G09B 7/00

(52) U.S. Cl. 434/322

(57) ABSTRACT

A method of aiding in the educational success of a student includes conducting a first meeting with parent(s) or guardian(s) of the student and a predetermined team of teachers. A communication encouraging the same stakeholders to attend a series of recurring meetings includes nonthreatening community type words. A school administrator synchronizes the schedules of at least the team of teachers with the recurring meeting schedule. The method includes conducting each of the recurring meetings at the predetermined location in an informal way in order to encourage building a collaborative relationship between the team of teachers and the parent(s) or guardian(s), wherein the recurring set of meetings at the beginning of the school year include discussions which focus on expectations, various course assignments, and grading, and wherein the recurring set of meetings as the school year progresses includes discussions focused on student achievement.

### TECHNICAL FIELD

This application relates generally to methods and techniques of improving scholastic performance. More specifically, this application relates to a method and system including a planned and organized system of meeting with parents and students on a regular basis including regular informal meetings, collaborating and building relationships with families and the community.

### BACKGROUND

Various techniques, methodologies, and requirements exist that attempt to aid in the educational success of students. Some programs have shortcomings. In the United States the No Child Left Behind (NCLB) Act of 2000, implemented by the federal government, requires all United State schools to prove Adequate Yearly Progress (AYP) of the students. In order to achieve AYP students need to increase their scores on standardized tests that they take each year. Regardless of whether or not a student receives an ‘A’ in a particular class, the following year they are expected do better on the associated standardized tests. This one-size-fits-all approach lacks individualized focus.

### SUMMARY OF THE INVENTION

What is needed is an approach that is better customized to each student, and which involves the greater community of people involved with the educational success of children. Various embodiments in accordance with the current disclosure provide a planned and organized system of meetings with parents and students on a regular basis. Embodiments may provide a system which involves parents coming to the school to meet with their children's teachers at regular intervals, for example once a week, in an informal manner.

Traditional teacher/parent conferences typically involve parents and teachers sitting in a formal setting with everyone in a chair around a table taking turns to speak. Embodiments in accordance with the present disclosure may include parents of a particular child coming to a designated room, for each of a plurality of recurring meetings, wherein the teachers of that child may be already present and waiting for them, or who may arrive shortly thereafter. The discussions during the recurring meetings in the beginning of the year may be more like an open house, where teachers may explain, for example, expectations, course assignments, grading, etc. As the year progresses, and parents and teachers get to know one another, the time during the recurring meetings may become centered on how students may better achieve academically. It has been observed that parents and students may be receptive to this approach because of the earlier meetings and the regular, i.e., once-a-week open door policy.

Embodiments in accordance with the present disclosure may be referred to as a Parent Collaboration Professional Learning Community, or PC PLC. The PC PLC may involve collaborating and building relationships with families and the community (as parents are part of the community relating to their jobs). The more educators, parents, and the community (businesses) can know what is going on and how to help the more the education system, and students, may be able to succeed.

Embodiments may follow various methods, or processes. One process may include communicating to various stakeholders, for example, administration personnel, teachers, staff, students, parents, and families about the program. The communication may include sending home fliers with the students, or via other means.

Embodiments may include getting permission from the administration of the school for starting the program and permission to meet weekly. The permission may “protect” the day of either or both of the initial meeting or the recurring meetings from conflicting meetings that may also be scheduled for the venue of the meeting and/or the various stakeholders. The permission and/or scheduling may also allow, or notify the rest of the school, personnel, and staff members to be aware of the stakeholders' location on the day of the event for which they are needed. In some embodiments, administration support in a school may be important, since the principal is in ‘charge’ of all activities and is ultimately responsible. The principal's support may vary from approving the meetings on the specified days of the week to holding at least school personnel accountable to participate.

The process may involve getting commitments from teachers to participate, selecting a ‘lead’ teacher and securing a place to meet. The meeting locations may be the same for each ‘team’ of teachers for each recurring time period, i.e., week to week. The location for each meeting may be, for example, one of the team's class rooms. One or more other meetings may also be held, for example, larger, or group meetings which may, for example be held at one time, or occasionally or periodically for celebrations, social gatherings, or to share information and provide training, and the like. In the case of group meetings a larger place to meet may be necessary and may need to be secured.

The process may also include gathering, calculating, analyzing and reporting data, maintaining communication, addressing issues, managing data including attendance and feedback forms. It may also, or instead, involve staying on top of teacher/administration issues, parent/teacher issues, and making sure everything is running smoothly and positively in a forward motion toward student success.

Various methods may utilize communications that may include but may not be limited to, e-mails, phone calls, fliers, notes sent home, announcements and the like to inform and notify families of the program and meetings.

Methods may include extending invitations for parents to attend; and offering various incentives for attendance. The incentive may include, for example giving students extra-credit points for bringing back the invitees, and/or attending meetings with their parents. Various embodiments in accordance with the disclosure may include forms. The forms may be, may include, may identify, may summarize or may describe such things as daily homework logs, sheets, fliers, feedback surveys, attendance sheets, PC PLC fliers with teachers and meeting places listed, and the like.

Various embodiments may incorporate various techniques to encourage attendance at the meetings. Particular words, wording, or phrases may be used to elicit positive responses, and/or friendly and inviting feelings. Such words or phrases may include, but may not be limited to: invite; we invite parents and students to meetings; we “want” them to attend, we “encourage” participation. Incentives, positive reinforcements, and the like have been found to create a positive atmosphere for building relationships between the school and family members. Inviting wording may be used which may be specifically selected to be welcoming to parents. The parents may be asked to join and support the program by attending. Communications to the parents may explain data and examples that may illustrate a need for, and the effectiveness of, meeting, and how similar programs have changed students for the better. The communication may explain how the program opens up communication between homes and schools, “Bridging the Gap”, and how it supports students and helps them to succeed.

Various embodiments may also encourage parents to bring with their child, or to be shown, class work, notebooks and or other evidence of activities assigned by teachers and completed by the student(s).

Embodiments may be based on a process of building an organization to bridge the gap between home and school. The process may be considered to be primarily based on the premise of the “power of the parent’.

In some school settings, there may be a different teacher for each subject. The “team of teachers” approach, in accordance with the present disclosure, may better uncover a problem the student may be experiencing. For example, a reading disability encountered in all subjects may be more readily recognized and dealt with if all of the teachers are simultaneously present when the question first arises.

With some embodiments all teachers in a particular school, or all the teachers who may teach, or be involved with, any of the students in a particular group, may be invited, encouraged, or required to participate. In some cases teachers may teach primarily on a team including, for example, four core subjects; math, language arts, science and history. In some cases only these core teachers may be on a team of teachers invited to attend the meetings. In some cases other teachers may be invited, encouraged, or required to attend. These other teachers may include elective teachers, remediation teachers and the like.

Various embodiments have been shown to create a professional learning community based on trust, experience, knowledge, caring and passion. Meeting attendees may include, but may not be limited to, parents, students, administrators, teachers, other educators, business people, community people, and PTA people. Various methods in accordance with the disclosure may utilize website, and/or various forms of social media.

Various embodiments in accordance with the present disclosure may be applied to professional learning communities in organizations and in learning cultures. They may be applied to improve summer camp programs, university campus cultures, business environments, and the like. They may improve relationships between hospital/patient, medical/client, salesperson/customer (auto, products, insurance), retail/customer (department stores, etc). Embodiments may be made or used to improve any working relationship between two or more parties.

### BRIEF DESCRIPTION OF THE DRAWINGS

The drawings, when considered in connection with the following description, are presented for the purpose of facilitating an understanding of the subject matter sought to be protected.

FIG. 1 is a flow diagram illustrating an example method of aiding in the educational success of a student in accordance with various example embodiments.

FIG. 2 is a flow diagram illustrating an example method of aiding in the educational success of students in accordance with various example embodiments.

### DETAILED DESCRIPTION

While the present method of aiding in the educational success of a student is described with reference to several illustrative embodiments described herein, it should be clear that the present invention should not be limited to such embodiments. Therefore, the description of the embodiments provided herein is illustrative of the present invention and should not limit the scope of the invention. In addition, while the following description references drawings showing particular configurations and orders of operation, it will be appreciated that the invention may be configured to have other configurations and orders of operation.

Various aspects of the illustrative embodiments will be described using terms commonly employed by those skilled in the art to convey the substance of their work to others skilled in the art. However, it will be apparent to those skilled in the art that alternate embodiments may be practiced with only some of the described aspects. For purposes of explanation, specific materials and configurations are set forth in order to provide a thorough understanding of the illustrative embodiments. However, it will be apparent to one skilled in the art that alternate embodiments may be practiced without the specific details. In other instances, well-known features are omitted or simplified in order not to obscure the illustrative embodiments.

Further, various operations will be described as multiple discrete operations, in turn, in a manner that is most helpful in understanding the present invention; however, the order of description should not be construed as to imply that these operations are necessarily order dependent. In particular, these operations need not be performed in the order of presentation.

The phrase “in one embodiment” may be used repeatedly. The phrase generally does not refer to the same embodiment; however, it may. The terms “comprising,” “having,” and “including” are synonymous, unless the context dictates otherwise.

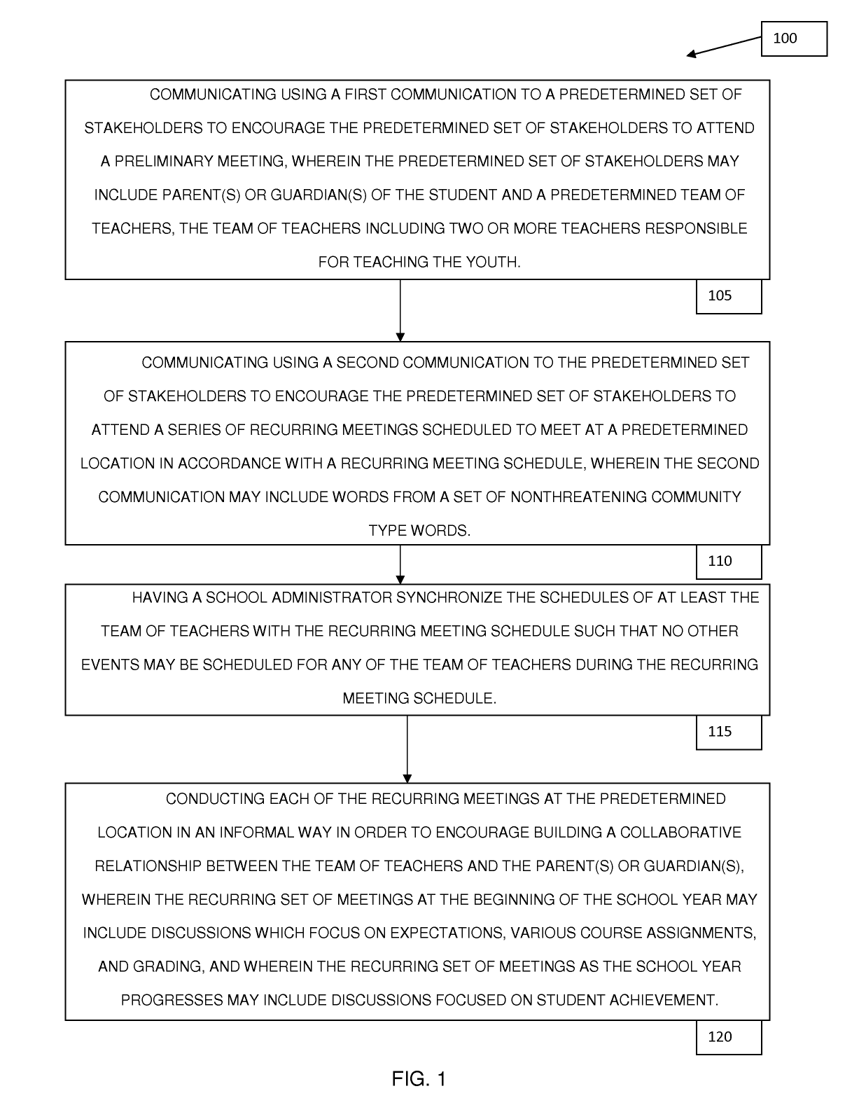

FIG. 1 is a flow diagram illustrating an example method of aiding in the educational success of a student in accordance with the present disclosure. The method 100 may include, at 105, communicating using a first communication to a predetermined set of stakeholders to encourage the predetermined set of stakeholders to attend a preliminary meeting, wherein the predetermined set of stakeholders may include parent(s) or guardian(s) of the student and a predetermined team of teachers, the team of teachers including two or more teachers responsible for teaching the student.

The method 100 may also include, at 110, communicating using a second communication to the predetermined set of stakeholders to encourage the predetermined set of stakeholders to attend a series of recurring meetings scheduled to meet at a predetermined location in accordance with a recurring meeting schedule, wherein the second communication may include words from a set of nonthreatening community type words.

The method 100 may also include, at 115, having a school administrator synchronize the schedules of at least the team of teachers with the recurring meeting schedule such that no other events may be scheduled for any of the team of teachers during the recurring meeting schedule.

The method 100 may also include, at 120, conducting each of the recurring meetings at the predetermined location in an informal way in order to encourage building a collaborative relationship between the team of teachers and the parent(s) or guardian(s), wherein the recurring set of meetings at the beginning of the school year may include discussions which focus on expectations, various course assignments, and grading, and wherein the recurring set of meetings as the school year progresses may include discussions focused on student achievement.

The method illustrated in FIG. 1 may also include selecting a lead teacher from the team of teachers. The method illustrated in FIG. 1 may also include getting commitment from each of the teachers to attend the meetings. The method illustrated in FIG. 1 may also include communicating the recurring meeting schedule and the predetermined location to school staff members and school administration personnel in order that they know where to find the team of teachers during meeting times.

The set of nonthreatening community type words may include words and/or phrases from the set consisting of: invite, want, request the honor of your presence, request, encourage you to attend, want, would appreciate.

The method illustrated in FIG. 1 may also include providing an incentive for the student to encourage their parent(s) and/or guardian(s) to attend as many as possible of each of the recurring meetings.

The method illustrated in FIG. 1 may also include gathering attendance data from each of the recurring meetings to determine how often the students had their parent(s) or guardian(s) attend the recurring meetings; and rewarding the student in accordance with the attendance data. The data may also include feedback from the students and their parent(s) or guardian(s) and or teachers to help determine how the students and their parent(s) or guardian(s) are benefitting from the reoccurring meetings.

The recurring set of meetings may be weekly meetings. The predetermined set of stakeholders may include school administration personnel, and school staff. The one or both of the first and the second communication may include sending home fliers with each student in a class of students. The predetermined team of teachers may include the student's math teacher, language arts teacher, science teacher, and history teacher. The predetermined team of teachers may further include the student's elective teacher and/or the youth's remedial education teacher.

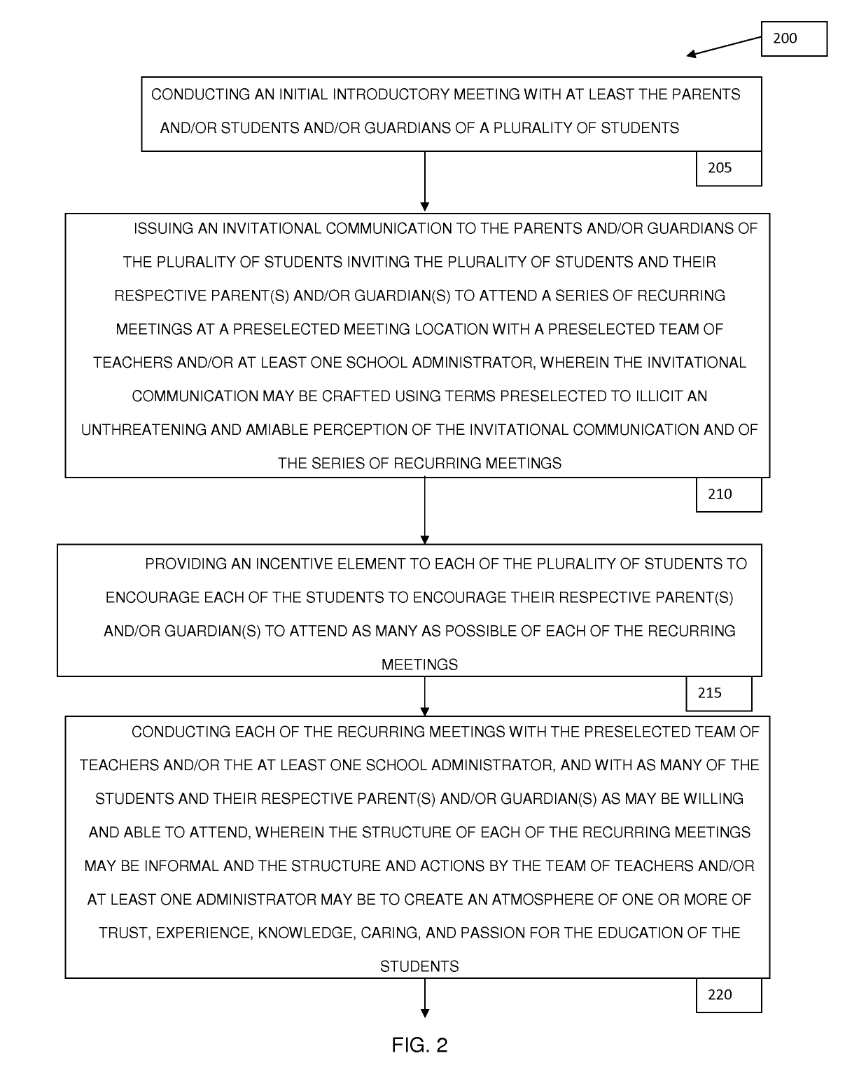

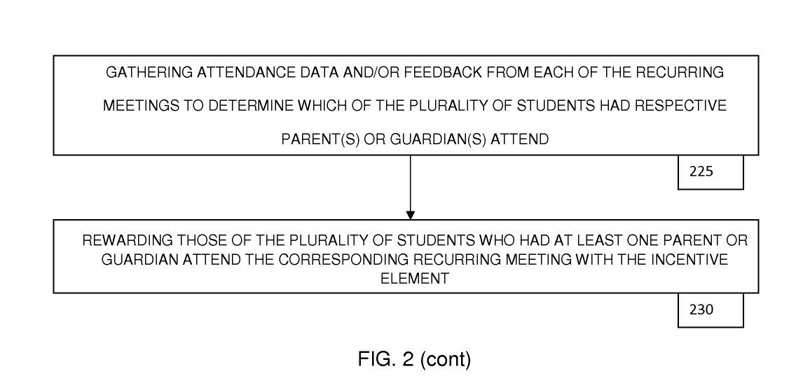

FIG. 2 is a flow diagram illustrating an example method of aiding in the educational success of students. The method 200 may include, at 205, conducting an initial introductory meeting with at least the parents and/or guardians of a plurality of students and/or the students.

The method 200 may include, at 210, issuing an invitational communication to the parents and/or guardians of the plurality of students inviting the plurality of students and their respective parent(s) and/or guardian(s) to attend a series of recurring meetings at a preselected meeting location with a preselected team of teachers and at least one school administrator, wherein the invitational communication may be crafted using terms preselected to illicit an unthreatening and amiable perception of the invitational communication and of the series of recurring meetings.

The method 200 may include, at 215, providing an incentive element to each of the plurality of students to encourage each of the students to encourage their respective parent(s) and/or guardian(s) to attend as many as possible of each of the recurring meetings.

The method 200 may include, at 220, conducting each of the recurring meetings with the preselected team of teachers and the at least and/or one school administrator, and with as many of the students and their respective parent(s) and/or guardian(s) as may be willing and able to attend, wherein the structure of each of the recurring meetings may be informal and the structure and actions by the team of teachers and/or at least one administrator may be to create an atmosphere of one or more of trust, experience, knowledge, caring, and passion for the education of the students.

The method 200 may include, at 225, gathering attendance data from each of the recurring meetings to determine which of the plurality of students had respective parent(s) or guardian(s) attend. The data may also include feedback from the students and their parent(s) or guardian(s) and/or teaches to help determine how the students and their parent(s) or guardian(s) are benefitting from the reoccurring meetings.

The method 200 may include, at 230, rewarding those of the plurality of students who had at least one parent or guardian attend (or themselves attend) the corresponding recurring meeting with the incentive element.

The conducting the recurring meetings may be such that the meetings at the beginning of the school year include discussing expectations, various course assignments, and grading; and the recurring meetings as the school year progresses may include focusing on student achievement.

The method may include obtaining administrative support from an administrative individual; and requesting the administrative individual to reserve on the schedules of each of the teachers on the team of teachers the meeting dates and times of the recurring meetings to encourage attendance of the teachers at the recurring meetings. The conducting each of the recurring meetings is conducting meetings once a week.

While the present disclosure has been described in connection with what is considered the most practical and preferred embodiment, it is understood that this disclosure is not limited to the disclosed embodiments, but is intended to cover various arrangements included within the spirit and scope of the broadest interpretation so as to encompass all such modifications and equivalent arrangements.

What is claimed is:

1. A method of aiding in the educational success of a student, the method comprising:
communicating using a first communication to a predetermined set of stakeholders to encourage the predetermined set of stakeholders to attend a preliminary meeting, wherein the predetermined set of stakeholders includes parent(s) or guardian(s) of the student and a predetermined team of teachers, the team of teachers including two or more teachers responsible for teaching the student;
communicating using a second communication to the predetermined set of stakeholders to encourage the predetermined set of stakeholders to attend a series of recurring meetings scheduled to meet at a predetermined location in accordance with a recurring meeting schedule, wherein the second communication includes words from a set of nonthreatening community type words;
having a school administrator synchronize the schedules of at least the team of teachers with the recurring meeting schedule such that no other events are scheduled for any of the team of teachers during the recurring meeting schedule; and
conducting each of the recurring meetings at the predetermined location in an informal way in order to encourage building a collaborative relationship between the team of teachers and the parent(s) or guardian(s), wherein the recurring set of meetings at the beginning of the school year include discussions which focus on expectations, various course assignments, and grading, and wherein the recurring set of meetings as the school year progresses includes discussions focused on student achievement.

2. The method of claim 1, further comprising getting commitment from each of the teachers to attend the meetings.

3. The method of claim 1, further comprising communicating the recurring meeting schedule and the predetermined location to school staff members and school administration personnel in order that they know where to find the team of teachers during meeting times.

4. The method of claim 1, further comprising selecting a lead teacher from the team of teachers.

5. The method of claim 1, wherein the set of nonthreatening community type words includes words and/or phrases from the set consisting of: invite, want, request the honor of your presence, request, encourage you to attend, want, would appreciate.

6. The method of claim 1, further comprising providing an incentive for the student to encourage their parent(s) and/or guardian(s) to attend as many as possible of each of the recurring meetings.

7. The method of claim 6, further comprising gathering attendance data from each of the recurring meetings to determine how often the students had their parent(s) or guardian(s) attend the recurring meetings; and
rewarding the student in accordance with the attendance data.

8. The method of claim 1, further comprising gathering feedback data from parent(s) or guardian(s) regarding the recurring meetings.

9. The method of claim 1, further comprising students attending the recurring meetings.

10. The method of claim 1, further comprising gathering feedback data from parent(s) or guardian(s) regarding the meetings.

11. The method of claim 1, wherein the recurring set of meetings are weekly meetings.

12. The method of claim 1, wherein the predetermined set of stakeholders includes school administration personnel, and school staff.

13. The method of claim 1, wherein one or both of the first and the second communication includes sending home fliers with each student in a class of students.

14. The method of claim 1, wherein the predetermined team of teachers include the student's math teacher, language arts teacher, science teacher, and history teacher.

15. The method of claim 1, wherein the predetermined team of teachers further includes the student's elective teacher and/or the youth's remedial education teacher.

16. A method of aiding in the educational success of students, the method comprising:
conducting an initial introductory meeting with at least the parents and/or guardians of a plurality of students;
issuing an invitational communication to the parents and/or guardians of the plurality of students inviting the plurality of students and their respective parent(s) and/or guardian(s) to attend a series of recurring meetings at a preselected meeting location with a preselected team of teachers and at least one school administrator, wherein the invitational communication is crafted using terms preselected to illicit an unthreatening and amiable perception of the invitational communication and of the series of recurring meetings;
providing an incentive element to each of the plurality of students to encourage each of the students to encourage their respective parent(s) and/or guardian(s) to attend as many as possible of each of the recurring meetings;
conducting each of the recurring meetings with the preselected team of teachers and the at least one school administrator, and with as many of the students and their respective parent(s) and/or guardian(s) as are willing and able to attend, wherein the structure of each of the recurring meetings is informal and the structure and actions by the team of teachers to create an atmosphere of one or more of trust, experience, knowledge, caring, and passion for the education of the students;
gathering attendance data from each of the recurring meetings to determine which of the plurality of students had respective parent(s) or guardian(s) attend; and
rewarding those of the plurality of students who had at least one parent or guardian attend the corresponding recurring meeting with the incentive element.

17. The method of claim 16, wherein the conducting the recurring meetings such that the meetings at the beginning of the school year include discussing expectations, various course assignments, and grading; and the recurring meetings as the school year progresses includes focusing on student achievement.

18. The method of claim 16, further comprising obtaining administrative support from an administrative individual; and
requesting the administrative individual to reserve on the schedules of each of the teachers on the team of teachers the meeting dates and times of the recurring meetings to encourage attendance of the teachers at the recurring meetings.

19. The method of claim 16, wherein the conducting each of the recurring meetings is conducting meetings once a week.
